(19) United States
(12) Patent Application Publication
(10) Pub. No.: US 2014/0045517 A1
(43) Pub. Date: Feb. 13, 2014

(54) SYSTEM FOR DETERMINATION OF REAL-TIME QUEUE TIMES BY CORRELATING MAP DATA AND MOBILE USERS' LOCATION DATA

(71) Applicant: POINT INSIDE, INC., (US)

(72) Inventors: Joshua L. MARTI, Bellevue, WA (US); Jonathan A. CROY, Seattle, WA (US)

(73) Assignee: POINT INSIDE, INC., Bellevue, WA (US)

(21) Appl. No.: 13/656,556

(22) Filed: Oct. 19, 2012

Related U.S. Application Data
(60) Provisional application No. 61/548,796, filed on Oct. 19, 2011.

(51) Int. Cl. H04W 4/04

(52) U.S. Cl. CPC H04W 4/04
USPC 455/456.1

(57) ABSTRACT

A system collects and correlates dynamic mobile user data location with a structure map and determined, for individuals and groups, average queue times for waypoints or average dwell time for areas within the structure. The determined times are made available for use.

### CROSS-REFERENCE TO RELATED APPLICATION

This application claims the benefit of the filing date of and incorporates by this reference the following application: 61/548,796, filed 2011 Oct. 19.

### FIELD OF THE INVENTION

The present invention relates generally to traffic flow models, and more particularly, to determining real-time queue times for waypoints within venues.

### BACKGROUND OF THE INVENTION

The following description includes information that may be useful in understanding the present invention. It is not an admission that any of the information provided herein is prior art or relevant to the presently claimed invention, or that any publication specifically or implicitly referenced is prior art.

Today, position determination is commonly used with maps and navigation in outdoor environments but not indoors. This is because the accuracy of indoor position determination systems relative to the elliptical model of the earth is not representative of the wireless device's true latitude longitude. Therefore, indoor map and navigation systems require a higher measurement resolution of position determination in the horizontal plane and vertical plane commonly seen as your floor number or level number in a structure. Because the GPS and cell signals do not provide the measurement resolution needed for indoor positioning. WiFi, Near Field Communications, RFID, Bluetooth and UWB are just some of the RF systems that offer signal measurement resolutions capable of providing the necessary position determination accuracy for single and multilevel structure.

Through the use of an indoor positioning determining entity in conjunction with a mapping service a wider range of information about any indoor structure and the user(s) within can be accessed and converted into functional data. In specific, there is no system which collects and then correlates dynamic mobile user data location with a structure map which can be used to derive average queue times for waypoints (known locations where queuing is known to occur) or average dwell time for areas (known locations where people tend to dwell) within a structure. A system which could collect multiple instances of mobile user data (time stamps of location or presence) near a known location and then calculate individual dwell time for all users passing through this location would be able to not only determine the average dwell time for this location, but also determine the average dwell time for different groups of individuals.

### BRIEF DESCRIPTION OF THE DRAWINGS

Exemplary embodiments are illustrated in the referenced figures. It is intended that the embodiments and figures disclosed herein are to be considered illustrative rather than restrictive.

FIG. 1 illustrates a block diagram of a real-time queue determining system according to the first embodiment of the present invention.

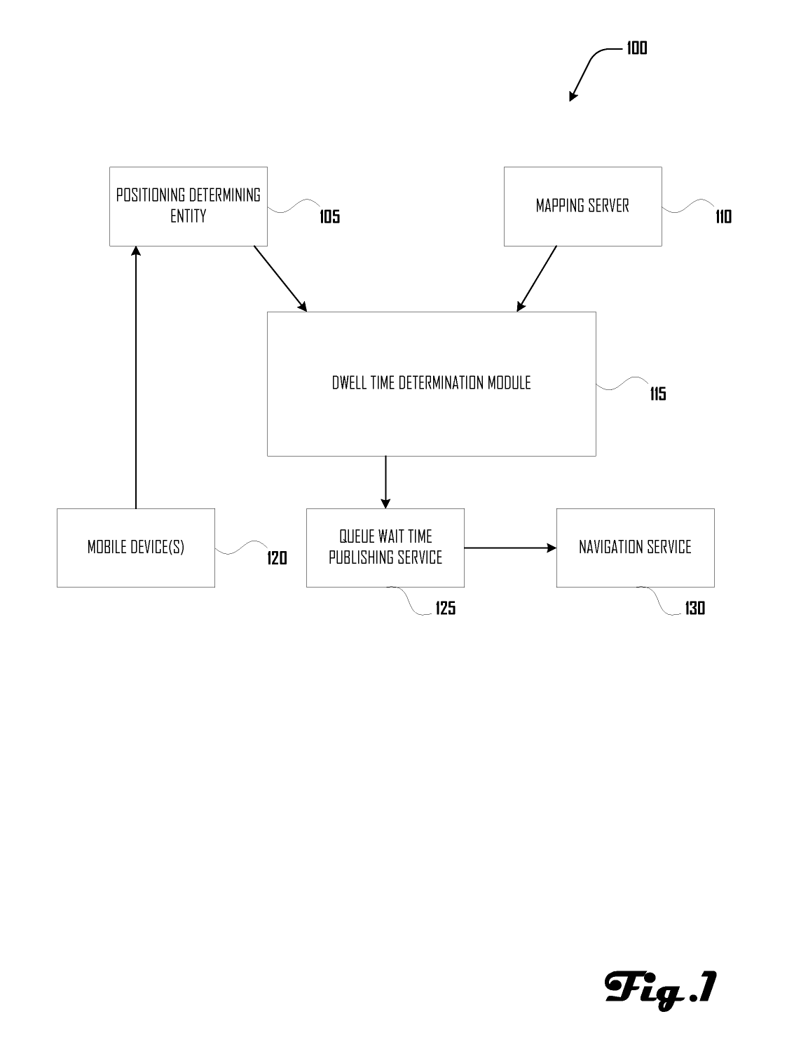

FIG. 2 illustrates a block diagram of a real-time queue determining system according to the second embodiment of the present invention.

FIG. 3 is a schematic drawing illustrating a pre-identified area designated as a “queuing location” with points indicating a single mobile device outside or inside of the queuing location.

FIG. 4A is a schematic drawing illustrating a pre-identified area designated as a “queuing location” with multiple devices outside or inside of the queuing location.

FIG. 4B is a graph illustrating average dwell time.

FIG. 5A is a schematic drawing illustrating a pre-identified area designated as a “queuing location” with multiple devices with variable queue times.

FIG. 5B is a graph illustrating average dwell time.

FIG. 6 illustrates a block diagram of a real-time queue determining system according to the first embodiment of the present invention.

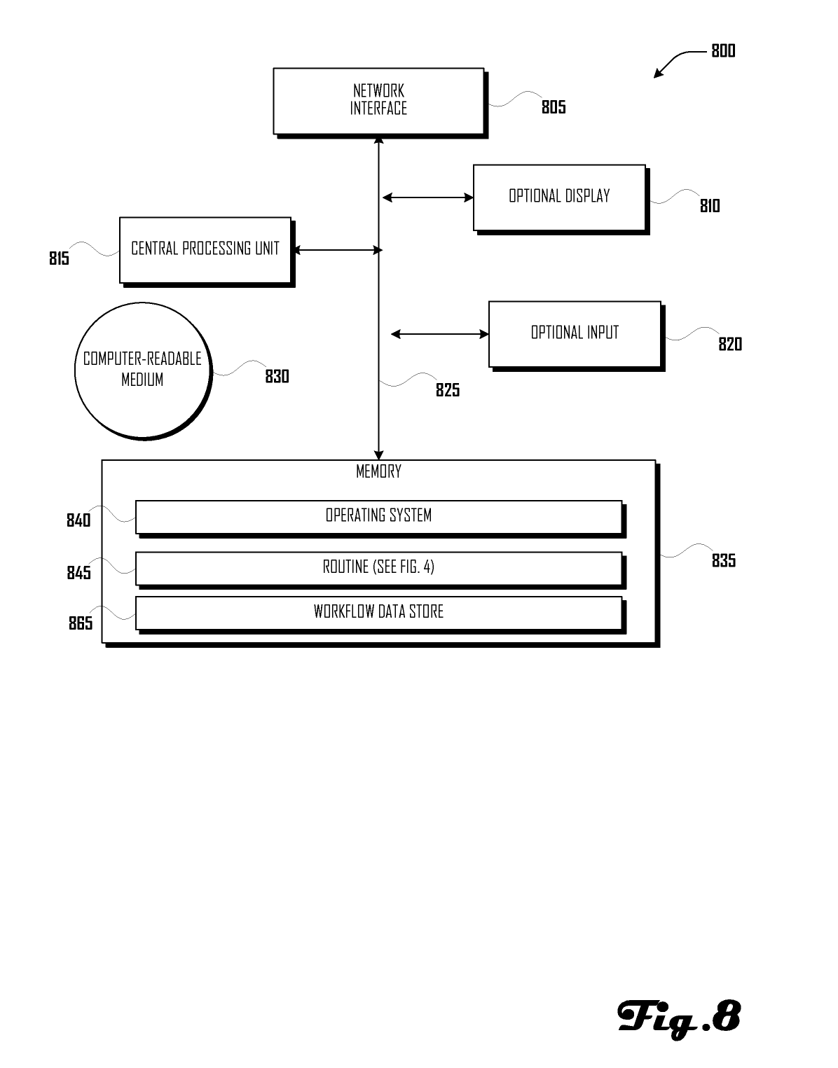

FIG. 7 illustrates a block diagram of a real-time queue determining system according to the second embodiment of the present invention.

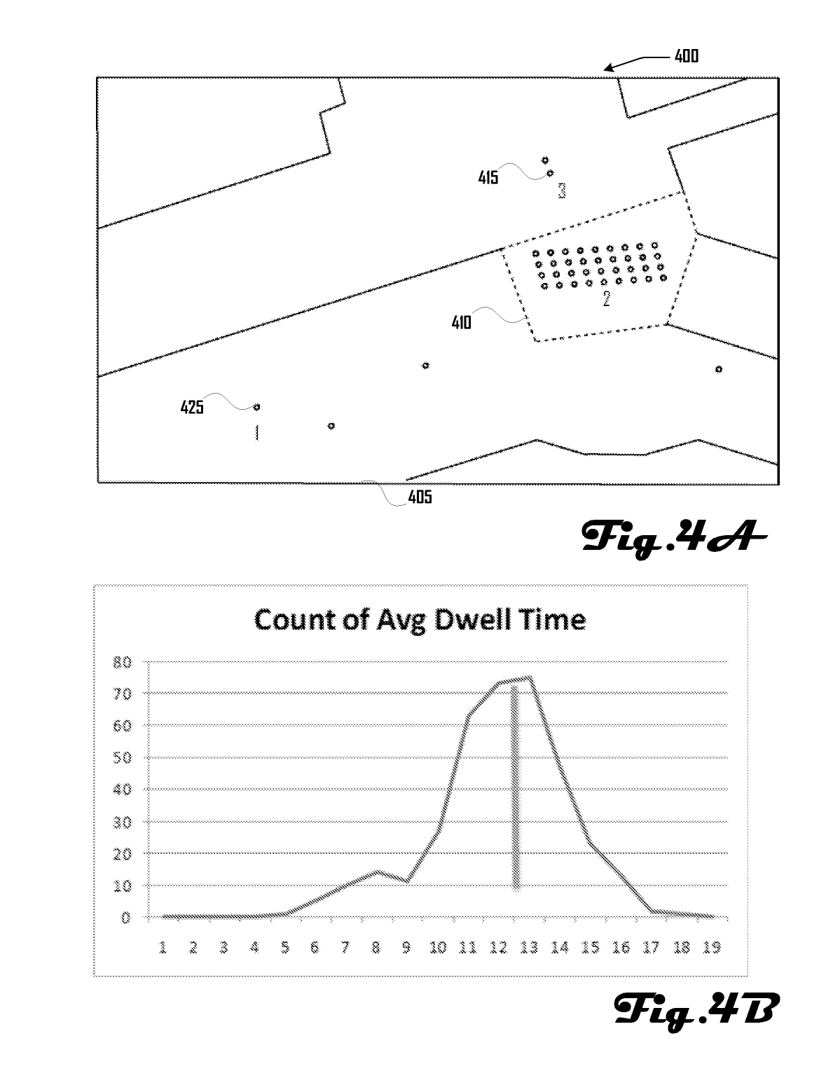

FIG. 8 is a functional block diagram of an exemplary computing device and some data structures and/or components thereof.

### DESCRIPTION OF THE INVENTION

One skilled in the art will recognize many methods, systems, and materials similar or equivalent to those described herein, which could be used in the practice of the present invention. Indeed, the present invention is in no way limited to the methods, systems, and materials described.

Embodiments of the present invention are directed to determining average queue time for a given location, which may be done by collecting a plurality of mobile user locations and comparing the dynamic state of this data to a structure map which can be used to derive average queue times for waypoints within the structure, and is referred to as real-time queuing. In the first embodiment described herein with reference to FIGS. (1) and (6), determining real-time queuing, may be done by identifying an area on a map where queuing occurs and collating a plurality of mobile user time stamps while they are located within the pre-determined location (dwell time). In this embodiment, the system (100) is configured for operative communication with a plurality of positioning determining entities 105 (a.k.a. “location server”) as well as a plurality of mapping services (110) over one or more wireless and/or wired communication networks.

As shown in FIG. (1), the system (100) comprises a plurality of applications or “modules” executable on one or more computers, such as one or more servers, one or more wireless devices (120), or any combination thereof. It should be appreciated that the various modules of the system (100) maybe logically or physically implemented and/or combined in a plurality of ways, and that the invention in not limited to the particular arrangement shown in FIG. (1). Each of the various modules of the system (100) is described below.

The system (100) comprises a positioning determining system or module (105) configured for establishing the location of the wireless device within any given structure. In addition to the location of the wireless device, the positioning determining system will also provide a device identification tag to distinguish individual devices along with a time stamp for each device. The positioning determining system itself is not limited to any one positioning determining entity and thus can be serviced by a variety of providers, e.g. a wireless location server connected to a wi-fi network, or a handset capable of producing accurate indoor location.

The system (100) also comprises a mapping service module (110) configured for creating a latitude and longitude (and altitude) framework for a structure or set of structures, such as a retail store, shopping center, airport, etc. (i.e., a reference geodetic datum). The mapping service itself may refer to the indoor positioning, mapping, and navigation system of Point Inside, but is not limited to any one mapping service system.

The system (100) also comprises a dwell time determination module (115) configured to create real-time queue times for pre-identified queuing locations. The dwell time determination module itself (115) comprises an application that defines an area of a structure to be surveyed, allowing the specification of areas of interest (e.g. areas of high queuing) to be monitored while excluding areas of non-interest. In addition, the dwell time determination module (115) comprises an application that collects and aggregates the time stamps of a plurality of mobile users that have been amassed by a positioning determining entity. In conjunction with an additional application that defines the mathematical processes to be applied, average dwell times can be calculated. In this embodiment, the dwell time determination module (115) calculates the average length of time that a plurality of mobile users spend amassed within the specified area of interest. What is to be appreciated is the fact that the module (115) is also able to recognize multi-modal distributions, thereby discriminating between differing patterns of queuing, such as different lines within a single queuing location.

The system (100) also comprises a publishing service module (125) configured to organize the output of the dwell time determination module (115) and subsequently publish this output on a near real-time basis so that other services may gain access to real-time queue times. A mobile application will then subscribe to this information allowing for the communication of the real-time queue times to user of this application.

The system (100) also comprises a navigation service module (130) configured to receive queue wait times from the publishing service. The navigation service will use this information to determine the best route through the structure as a function of calculated walking times factoring in the queue time to choose the best queue based on the shortest total walking time included queue time.

An example of the operation of the system (100) is provided below. The example is provided for explanatory purposes and should not be considered limiting in any way.

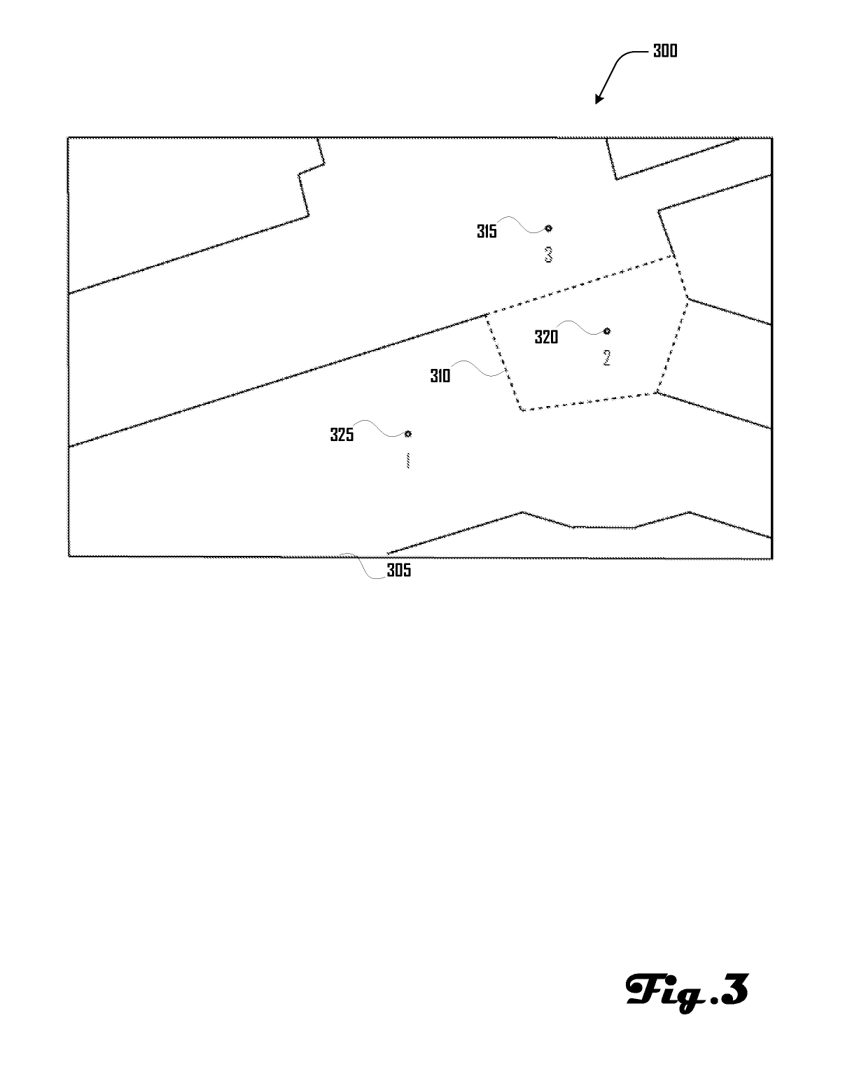

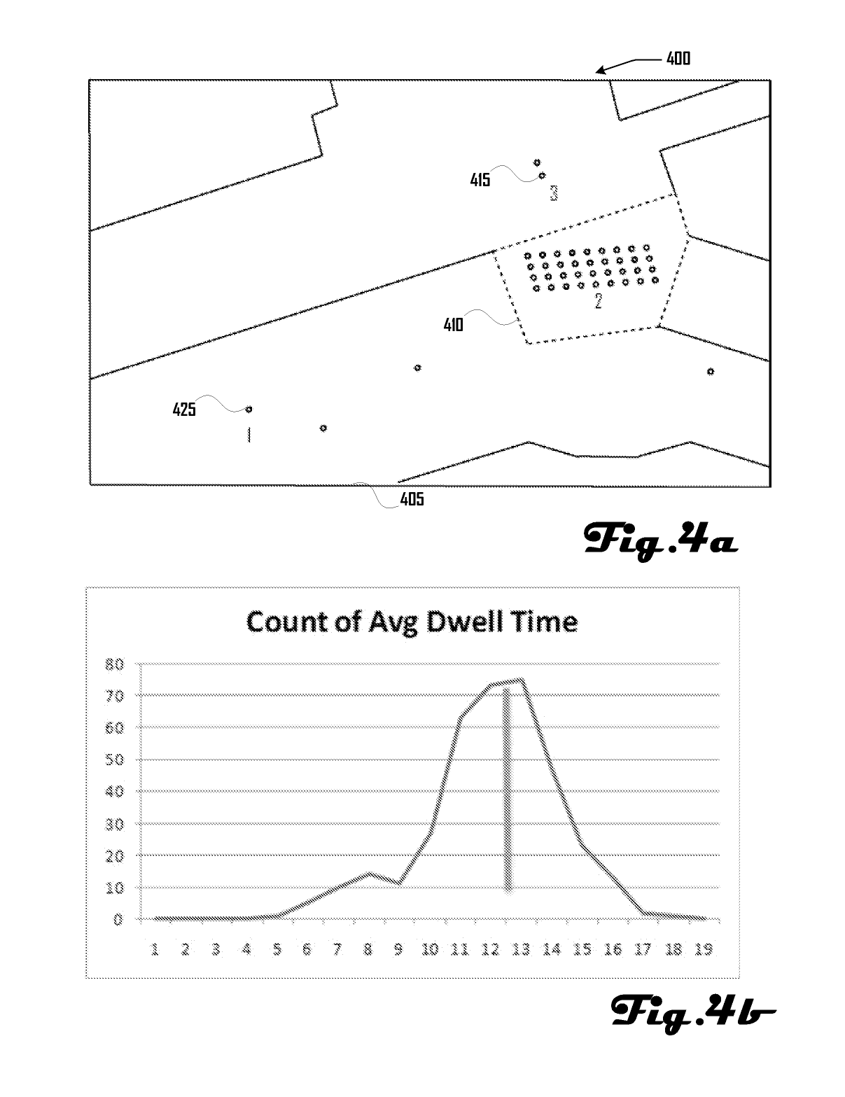

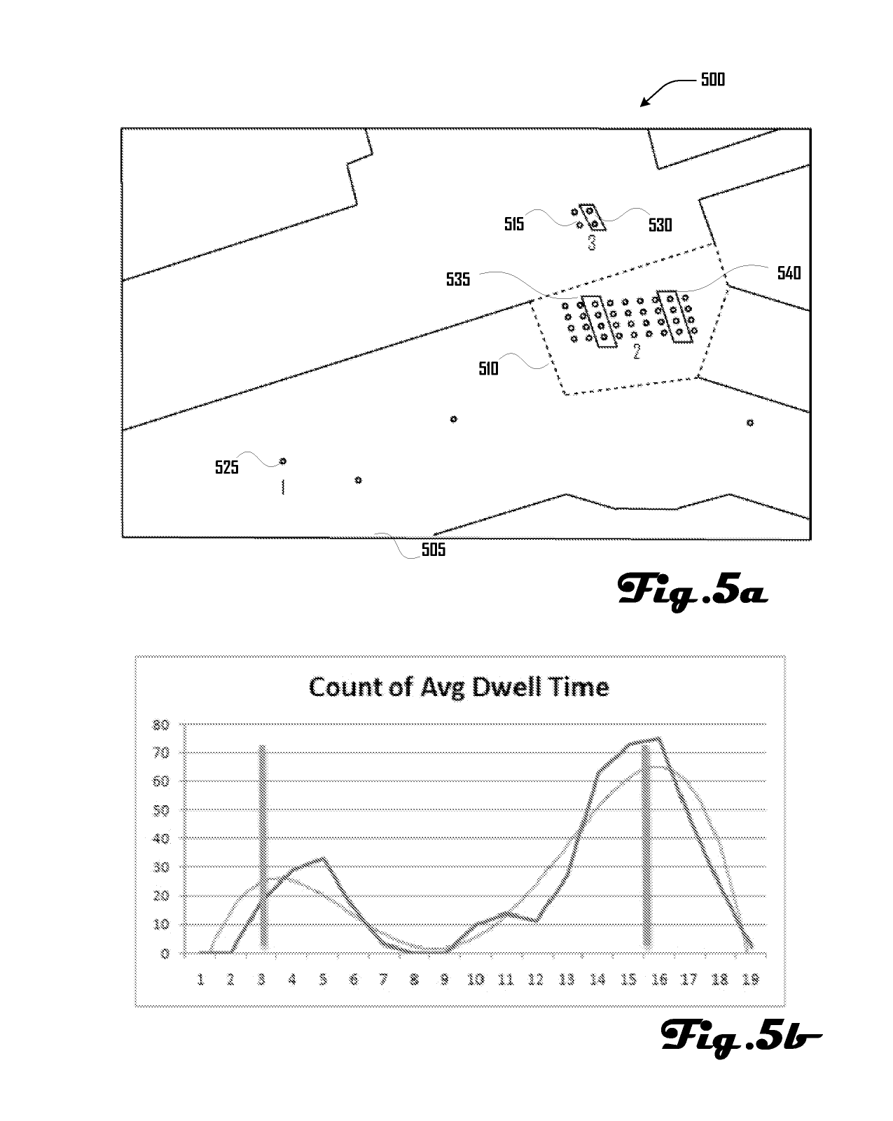

In one example (see FIGS. 3, 4a, 4b, 5a, and 5b), in an airport there is a wireless location server running and that server can provide access to a plurality of mobile users' location information to another server (Server 2), such as the dwell time determination module (115). In the Figures, mobile users are represented by small circles, for example, labeled with element numbers 315, 320, 325, 415, 425, 515, 525, and groups of mobile users labeled in boxes 530, 535, and 540. In FIG. (3), mobile user 315 and mobile user 325 are outside of the queuing location 310, while mobile user 320 is inside the queuing location 310. Server 2 will be collecting the location information and compare this user location data to known queuing areas within the airport by comparing the latitude/longitude/altitude from the location server to geographic data related to the map of the airport. Server 2 will assign a time stamp to each location event and track each event as the mobile user moves through the airport. Specifically, the server will watch location events that occur near known check points (e.g., TSA screening areas, custom areas), such as the area labeled 310, 410, and 510, and begin to calculate the average dwell time for a mobile user during their time located in that area. Server 2 will then aggregate all user data related to the known check point and publish average dwell time for this area in real-time so that other services can gain access to real-time queue times. A mobile application could subscribe to this information to communicate average wait time to users of the application. The application could then modify navigation routes based on the published average queue times.

The advantages of this embodiment include, without limitation, providing the ability utilize mobile user metadata in conjunction with mapping services to offer additional functional information; in this case, real-time queue times around areas of high traffic and congestion in locations such as airports and retail stores. Through the use of additional mobile services, this data can then be subscribed to from any number of mobile devices (mobile phones, tablets), providing the user with up to date wait times at various check points, thus enabling the user to choose the most time efficient path through any given structure. Through the use of additional mobile services, this data can then be subscribed to from any number of mobile devices or even a management console, providing insights to enable staff deployments within the location (e.g., additional staff can be deployed to an area where a lot of customers are dwelling; additional staff could be deployed to open checkout stands or security screening facilities).

FIG. (2) illustrate the operation of another embodiment of the present invention. In this embodiment, the system (200) is configured for determining real-time queuing by identifying an area on a map where queuing occurs and collating a plurality of mobile user time stamps once as they enter the specified area and again when they depart that area, creating a measurement of traffic flow through a specified queuing location. By determining the real-time queuing times according to this embodiment, the system (200) may perform similar functions including positioning determination, mapping, position and map correlation, and the like, as discussed above with reference to FIG. (1) and FIGS. (3) through (5b).

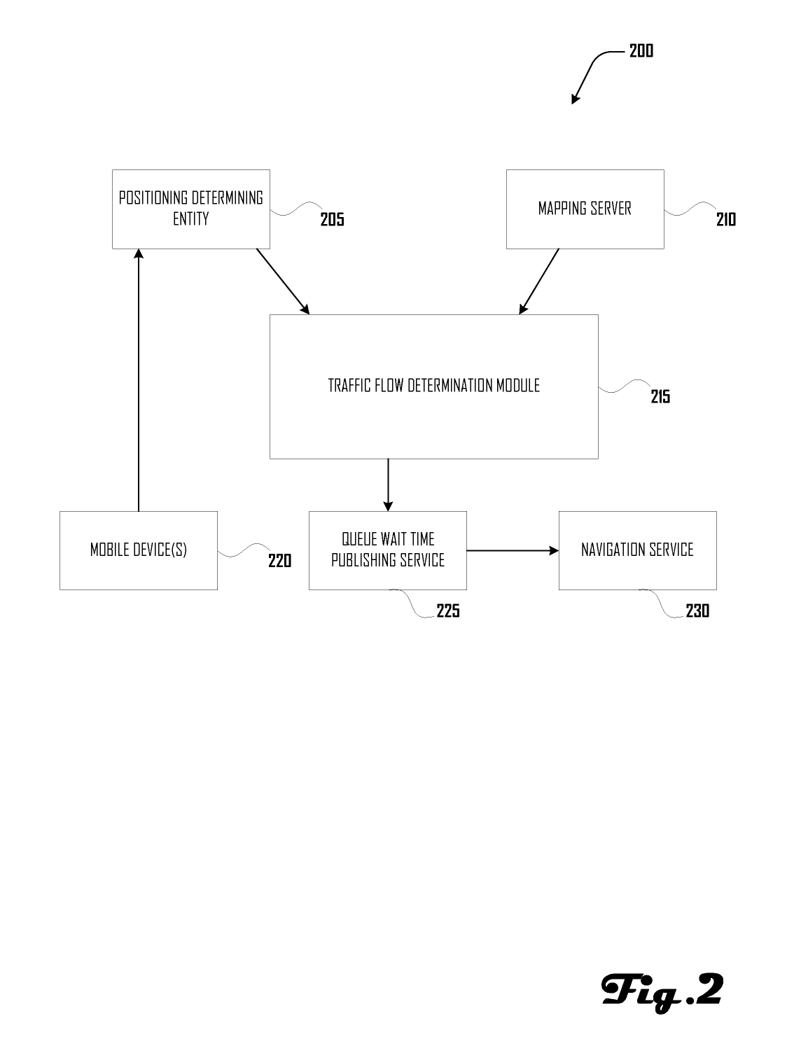

In the second embodiment of the present invention, illustrated in FIG. 2), the system (200) is configured for determining real-time queue times based on flow of traffic through a specified queuing location. As previously described, the system (200) comprises a position determining entity module (205), a mapping service module (210), a publishing module (225), and a navigation module (230). However, in the second embodiment, the dwell time determination module (115) is replaced with the traffic flow determination module (215).

The traffic flow determination module (215) is also configured to determine real-time queue times for pre-identified queuing locations. In this embodiment, it does so through comparing two separate time stamps for each individual mobile user; the first time stamp being created when the mobile user enters the pre-identified queuing location, the second time stamp being created when the mobile user exits the same queuing location. By calculating the lapse of time between each mobile user's time stamps, the traffic flow determination module (215) determines the length of time the mobile user has spent passing through the queuing location and collates this queue time with all the other mobile users also found within the pre-identified queuing location, thereby determining the average queue time for the location. As with the dwell time determination module (115), the traffic flow determination module (215) recognizes multi-modal distributions allowing for queuing times for two or more distinct categories, e.g. different queues within a single queuing area.

An example of the operation of the system (200) is provided below. The example is provided for explanatory purposes and should not be considered limiting in any way.

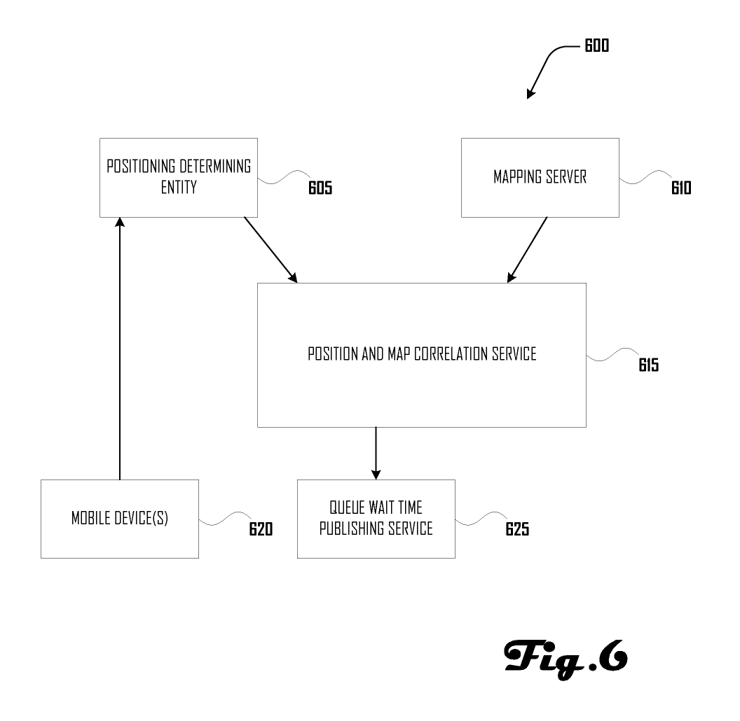

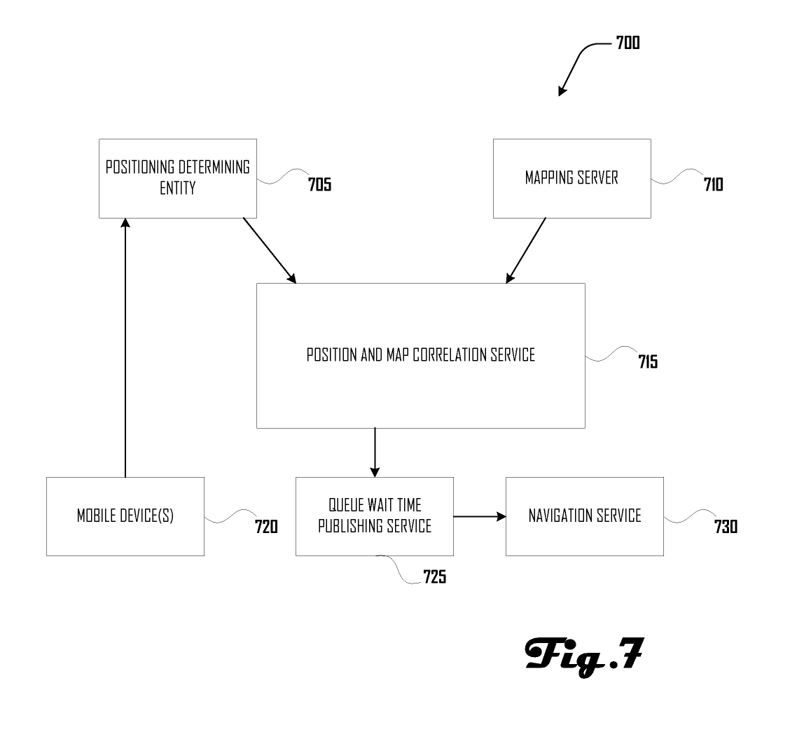

In this example (see FIG. 5), there are three lines through an airport security screening checkpoint. One line is for standard travelers. Another line is for premier travelers (e.g., those flying first class or with enough loyalty points to earn a privileged loyalty tier, like Delta Platinum Medallion) who are able to bypass the bulk of the line. The last line would be for credentialed employees (e.g., airport staff and airline staff) who require less screening than travelers. The system would be able to differentiate these three groups by recognizing that there were multiple means in the data distribution for the queuing time and thus create three different queue times for each category of security line. In FIG. (5a) there are multiple devices whose location is being reported and correlated to the queuing location. The system begins calculating the dwell time in that location until the device location is first reported outside of the queuing location. Several mathematical models could be used to calculate the average dwell time for a plurality of devices. When a bimodal distribution output occurs (as shown in the graph in FIG. (5b)), the system can recognize this and publish two (or more) sets of average queue times.

The advantages of this embodiment include, without limitation, providing the ability to utilize mobile user metadata in conjunction with mapping services to offer additional functional information; in this case, real-time queue times around areas of high traffic and congestion in locations such as airports and grocery stores. Through the use of additional mobile services, this data can then be subscribed to from any number of mobile devices (mobile phones, tablets), providing the user with up to date wait times at various check points, thus enabling the user to choose the most time efficient path through any given structure.

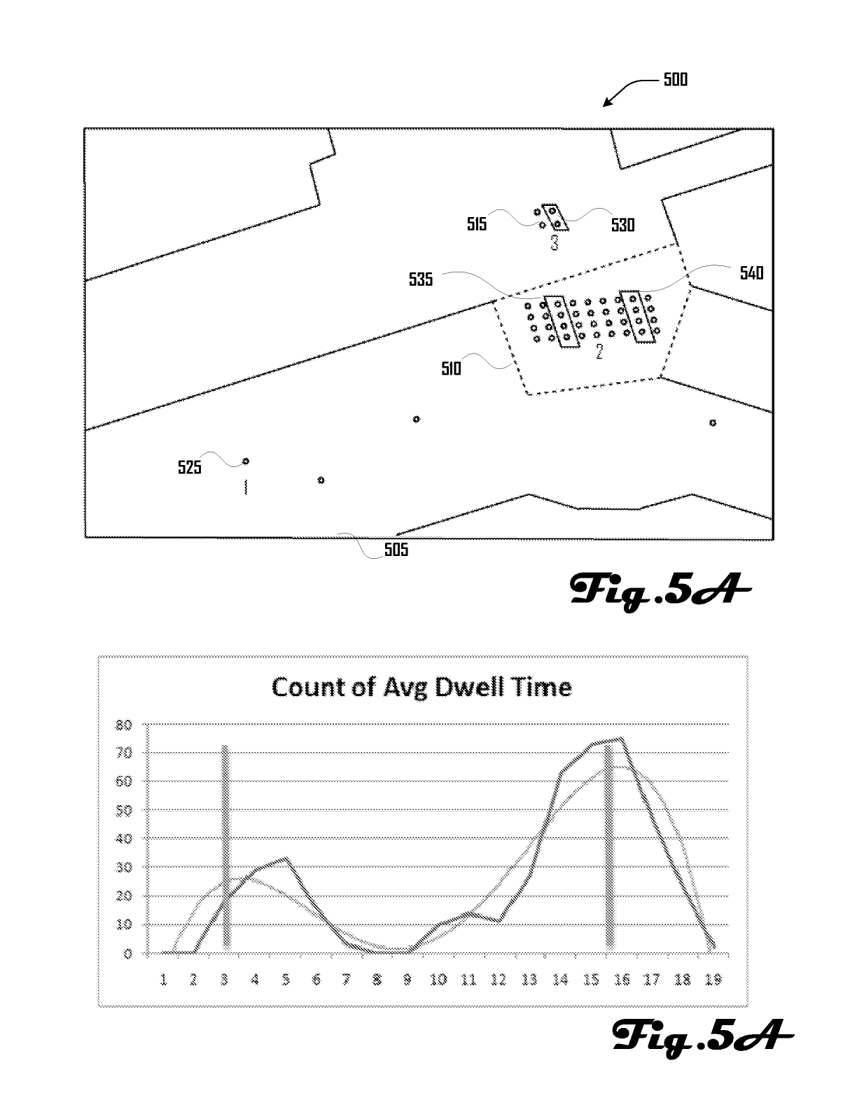

FIG. 8 is a functional block diagram of an exemplary computing device, in which the modules discussed above may be implemented. In some embodiments, the computing device (900) may include many more components than those shown in FIG. 8). However, it is not necessary that all of these generally conventional components be shown in order to disclose an illustrative embodiment. As shown in FIG. (8), the computing device (800) includes a network interface (805) for connecting to a network, such as the Internet.

The computing device (800) also includes at least one processing unit (815), memory (835), and an optional display (810), all interconnected along with the network interface (805) via a bus (825). The memory (835) generally comprises a random access memory (“RAM”), a read only memory (“ROM”), and a permanent mass storage device, such as a disk drive or SDRAM (synchronous dynamic random-access memory). The memory (835) stores program code for software modules, such as, for example, the modules discussed above. In addition, the memory (835) also stores an operating system (840). These software components may be loaded from a non-transient computer readable storage medium (830) into memory (835) of the computing device (800) using a drive mechanism (not shown) associated with a non-transient computer readable storage medium (830), such as a floppy disc, tape, DVD/CD-ROM drive, memory card, or other like storage medium. In some embodiments, software components may also or instead be loaded via a mechanism other than a drive mechanism and computer readable storage medium (830) (e.g., via network interface (805)).

The computing device (800) may also comprise hardware supporting optional input modalities, Optional Input (820), such as, for example, a touchscreen, a keyboard, a mouse, a trackball, a stylus, a microphone, and a camera.

Computing device (800) also comprises or communicates via bus (825) with data store (865). In various embodiments, bus (825) may comprise a storage area network (“SAN”), a high speed serial bus, and/or via other suitable communication technology. In some embodiments, computing device (800) may communicate with data store (865) via network interface (805).

1. A method for determination of real-time queue times by correlating map data and mobile device's location data in a computer comprising a memory, the method comprising:
with a position determining module, obtaining locations of a plurality of wireless devices in a framework for a structure;
with a dwell time determination module, determining the average length of time that a plurality of mobile devices spend in at least one defined area within the framework as a dwell time;
with a publishing service module, organizing and making available the dwell time determined by the dwell time determination module;
with a navigation service module, receiving the dwell time from the publishing service module and calculating walking times through the structure, which walking times factor in the dwell time.

2. The method of claim 1, wherein the position determining module further provides device identification tags to individual mobile devices and assigns time stamps for location events relating to the at least one defined area.

3. The method of claim 2, wherein a location event occurs when a mobile device passes into or out of the at least one defined area.

4. The method of claim 3, wherein the dwell time is determined by calculating the difference between the time stamps for the location events.

5. The method of claim 4, wherein the dwell time is determined relative to a portion of a day.

6. The method of claim 1, wherein the dwell time determination module further determines that a first set of mobile devices within the plurality of mobile devices passes through the at least one defined area in a first average time while a second set of mobile devices within the plurality of mobile devices passes through the defined area in a second average time and wherein the first and second average times are dwell times.

7. The method of claim 1 wherein the publishing service module outputs to subscribing mobile devices.

8. The method of claim 1, wherein the navigation service module determines the shortest total walking time of a route through the structure, which route includes the at least one defined area, factoring in the dwell time.

9. The method of claim 8, further comprising receiving a subscription to the calculated walking times from at least one of a mobile devices and a management console.

10. The method of claim 1, wherein a mapping module comprises data for the framework and wherein the framework comprises a latitude, longitude and altitude coordinate system.

11. The method of claim 1, wherein the position determining module is at least one of a wireless location server connected to a wi-fi network and a mobile device in the plurality of mobile devices.

12. A computer system with a computer readable medium comprising instructions which, when executed, perform the method according to claim 1.

13. A method for determination of real-time queue times by correlating map data and mobile device location data in a computer comprising a memory, the method comprising:
with a position determining module, providing device identification tags to individual mobile devices and time stamps to individual mobile devices as they enter and exit a defined area in a framework for a structure;
with a traffic flow determining module, determining a queue time for an individual mobile device passing through the defined area by calculating the difference between the time stamps;
with a publishing service module, organizing and making available the queue times determined by the traffic flow determination module.

14. The method of claim 13, wherein the traffic flow determining module further determines an average queue time for the defined area by collating the queue times for multiple mobile users passing through the defined area and averaging the collated queue times.

15. The method of claim 14, wherein the dwell time determination module further determines that a first set of mobile devices passes through the defined area in a first average time while a second set of mobile devices passes through the defined area in a second average time.

16. The method of claim 13, wherein the position determining module is provided by at least one of a wireless location server connected to a wi-fi network and a handset capable of producing accurate indoor location.

17. The method of claim 13, wherein the framework for the structure comprises at least one of a latitude, longitude and altitude coordinate system and a geodetic datum.

18. The method of claim 13, wherein the structure is one of a retail store, shopping center, and an airport.

19. The method of claim 13, further comprising a navigation service module, which navigation service module receives the queue times from the publishing service module and calculates walking times through the structure, which walking times factor in the queue times.

20. A computer system with a computer readable medium comprising instructions which, when executed, perform the method according to claim 13.
